(19) United States
(12) Patent Application Publication
(10) Pub. No.: US 2019/0160841 A1
(43) Pub. Date: May 30, 2019

(54) STAMP

(71) Applicant: Stampin' Up! Inc, Riverton, UT (US)

(72) Inventors: Julie Alusa, Kearns, UT (US); Kathy Pitt, Taylorsville, UT (US); Emily Walker, Riverton, UT (US)

(73) Assignee: Stampin' Up! Inc., Riverton, UT (US)

(21) Appl. No.: 15/828,282

(22) Filed: Nov. 30, 2017

(51) Int. Cl. B41K 1/38; B41C 1/02

(52) U.S. Cl. CPC B41K 1/38; B41C 1/02

(57) ABSTRACT

The stamp comprises a base and a stamping surface. The stamping surface includes one or more singularities; one or more conjoined singularities; and one or more fused singularity sections all of substantially uniform height. The singularities can be protrusions separated by one or more gaps. The conjoined singularities can include one or more connections between them, wherein the connections are substantially the same height as the stamping surface and can be part of the stamping surface. A method of manufacturing an improved stamp is also disclosed.

### BACKGROUND

In crafting, stamps are widely used to apply designs, lettering and other images to an article. As discussed further below, a typical stamp includes a base and a raised stamping surface of substantially uniform height. The stamp can be affixed to a handle or some other stamping tool such as a stamp press. In operation, a user would apply ink to the stamping surface. This is usually done by pressing the stamp into an ink source such as an ink pad, though one could simply apply the ink directly to the stamping surfaces with a cloth or brush or sponge or other applicator. Once the stamping surface has ink applied, the stamp is pressed onto an article to be stamped. Typical articles that can be stamped include but are not limited to paper, cardboard, wood, glass and metal.

When in proper use, only the stamping surfaces will make contact with the article when the stamp is pressed down. When a stamped image of uniform shading is desired, such a stamping system is perfectly adequate.

Prior art stamping systems have generally discussed the use of dot matrix to allow for shading in stamping devices. However, for best detailed stamping, it is preferred to have areas of high density stamping surfaces, areas of low density stamping surfaces and also areas of solid stamping surfaces. The systems described in the prior art do not allow for the solid stamping surfaces and as such, even when dots are close together, it allows for areas where there is no ink. As such, portions of the stamped image can look grainy when solid color is desired. Moreover, even when the dots are close together, there is still the possibility that the ink will not uniformly spread between such dots and may end up in the spaces between. As such, much of the desired detail can be lost.

The present invention in its various embodiments allows for a single stamp to create an image that has a variety of shading elements and thus a higher level of realism.

### SUMMARY

The present invention in its various embodiments is an improved stamp. The stamp comprises a base and a stamping surface. The stamping surface includes one or more singularities; one or more conjoined singularities; and one or more fused singularity sections all of substantially uniform height. The singularities can be protrusions separated by one or more gaps. The singularities can be substantially polygonal in cross-sectional shape or substantially circular in cross-sectional shape. The singularities can have a top surface that is substantially flat or substantially rounded. The gaps can be substantially polygonal or substantially circular. The conjoined singularities can include one or more connections between them, wherein the connections are substantially the same height as the stamping surface and can be part of the stamping surface. The connections can be substantially horizontal, substantially vertical or substantially diagonal.

A method of manufacturing a stamp is also disclosed. In the method a graphical stamp image is created. The graphical stamp image has a dots per inch (DPI) setting of approximately 300-1500; a bitmap setting of approximately 600-1500; a lines per square inch (LSI) setting of approximately 45-85 and a lightest area setting of approximately 7-80 percent black. A three-dimensional likeness of the graphical stamp image is engraved into a quantity of magnesium. One or more matrix boards is formed from the engraved three-dimensional likeness of the graphical stamp image in the magnesium. A quantity of precursor material is deposited into the matrix boards and heat is applied. As the precursor materials melt, they assume the negative shape of the matrix boards. Once cooled, they are removed from the matrix boards thereby forming the stamp. In one embodiment, the graphical stamp image has a dots per inch (DPI) setting of approximately 600; a bitmap setting of approximately 1200; a lines per square inch (LSI) setting of approximately 65-80 and a lightest area setting of approximately 15 percent black. The precursor materials can be red rubber. The magnesium can be in the form of a magnesium plate.

### BRIEF DESCRIPTION OF THE DRAWINGS

FIG. 1 depicts a conventional red rubber stamp affixed to a wooden block.

FIG. 2 depicts the stamp of FIG. 1 after having ink applied.

FIG. 2b depicts a stamped image created by a conventional stamp.

FIG. 3 depicts a stamp according to one embodiment of the present invention.

FIG. 4 depicts a magnified view of a stamp according to one embodiment of the present invention.

FIG. 5 depicts a further magnified view of a stamp according to one embodiment of the present invention.

FIG. 5b depicts an even further magnified view of a stamp according to one embodiment of the present invention.

FIG. 6 depicts a stamp with ink applied according to one embodiment of the present invention.

FIG. 7 depicts a magnified view of a stamp with ink applied according to one embodiment of the present invention.

FIG. 8 depicts a further magnified view of a stamp with ink applied according to one embodiment of the present invention.

FIG. 9 depicts a stamped image created by the present invention according to one embodiment.

FIG. 10 depicts a stamped image created by the present invention according to one embodiment.

FIG. 11 depicts a stamped image created by the present invention according to one embodiment.

FIG. 12 is a tabular overview of certain pixilation settings according to one embodiment of the present invention.

### DESCRIPTION OF ILLUSTRATED EMBODIMENTS

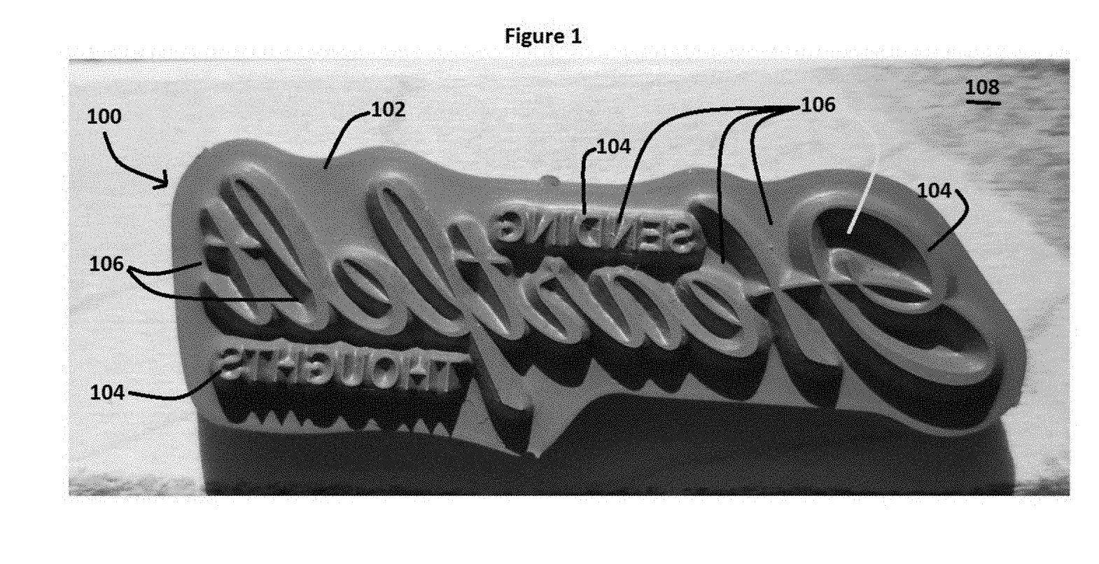

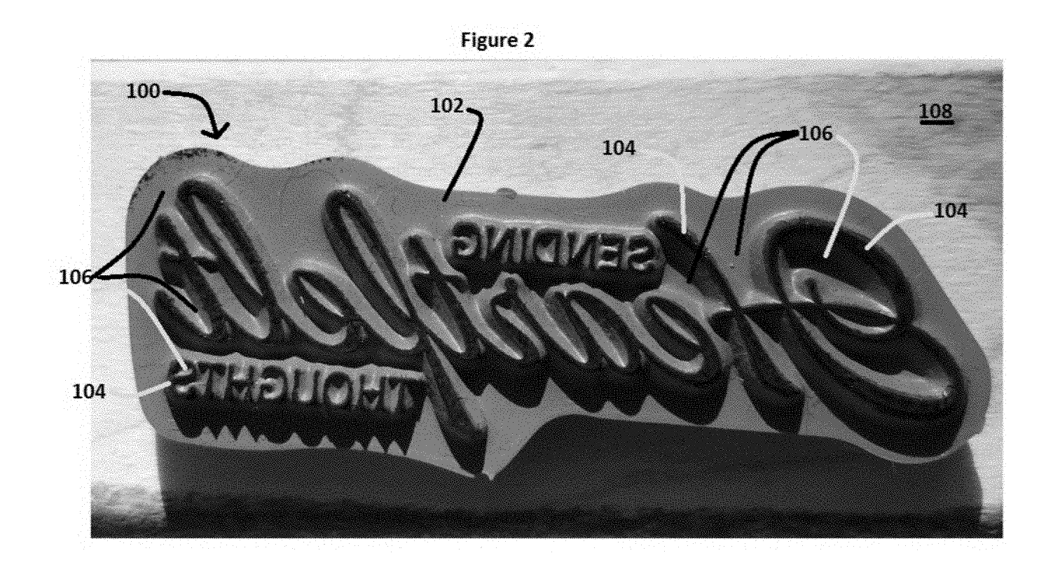

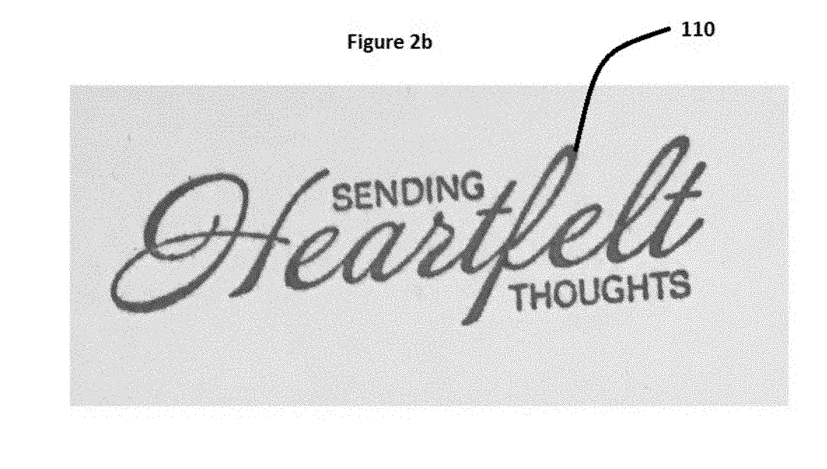

Referring to FIGS. 1-2b, a conventional stamp 100 is depicted. The stamp 100 includes a base portion 102 base portion with a raised stamping surface 104 of substantially uniform height. The stamping surfaces 104 include various spaces 106 interspersed among the stamping surfaces 104 that do not typically interface with the article to be stamped when used.

In operation, a user would apply ink to the stamping surface 104. This could be done by pressing the stamp 100 into an ink source such as an ink pad or one could simply apply the ink directly to the stamping surfaces 104 with a cloth or brush or sponge or other applicator as would be apparent to one skilled in the art. Once the stamping surfaces 104 have ink applied, the stamp 100 is then pressed onto an article to be stamped. Typical articles that can be stamped include but are not limited to paper, cardboard, wood, glass and metal. A block or other similar handle device 108 can be used in pressing the stamp 100 to the article.

When in proper use, only the stamping surfaces 104 will make contact with the article when the stamp 100 is pressed down. Spaces 106 in the stamping surfaces 104 may have residual ink in them, but will not generally come into contact with the article when the stamp 100 is used.

As noted above, when a stamped image of uniform shading is desired as depicted at 110 in FIG. 2b, such a stamping system is perfectly adequate. However, the present invention in its various embodiments allows for a single stamp to create an image that has a variety of shading elements and thus a higher level of realism.

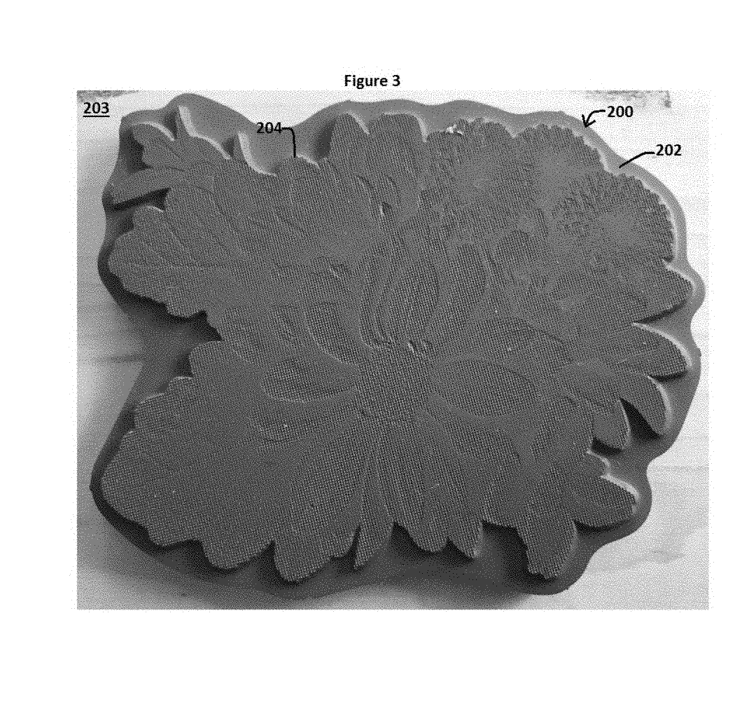

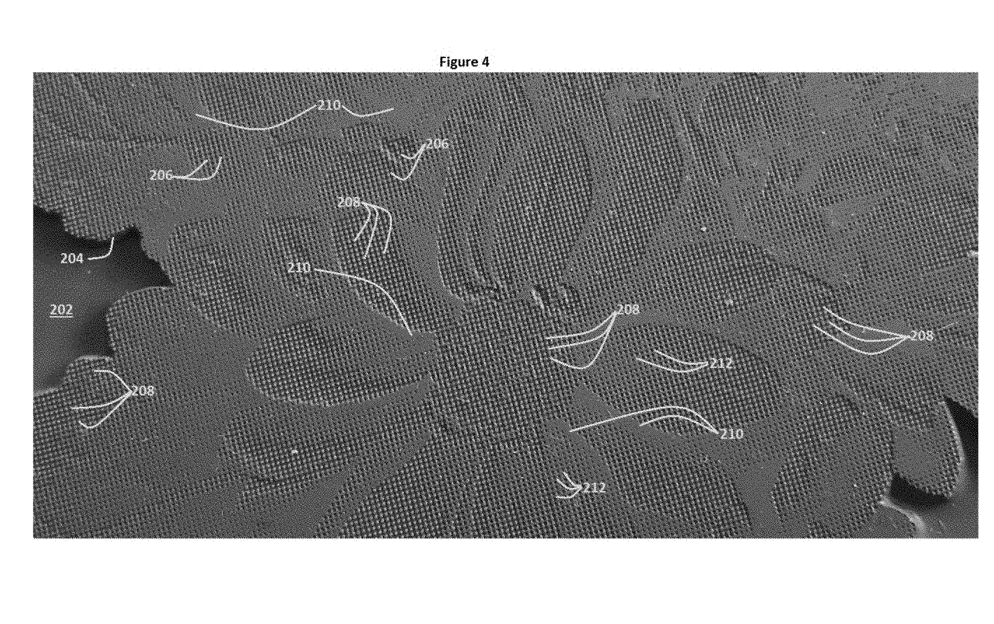

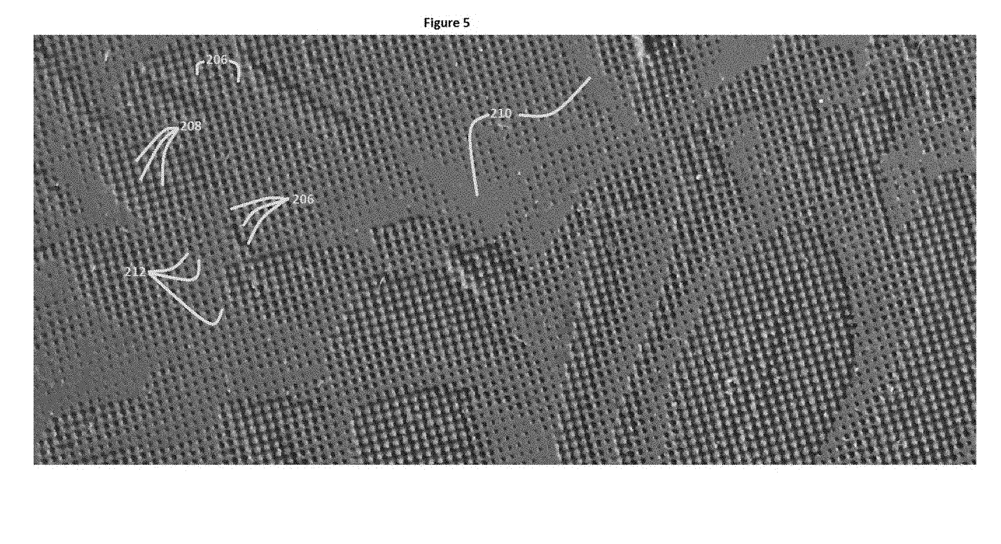

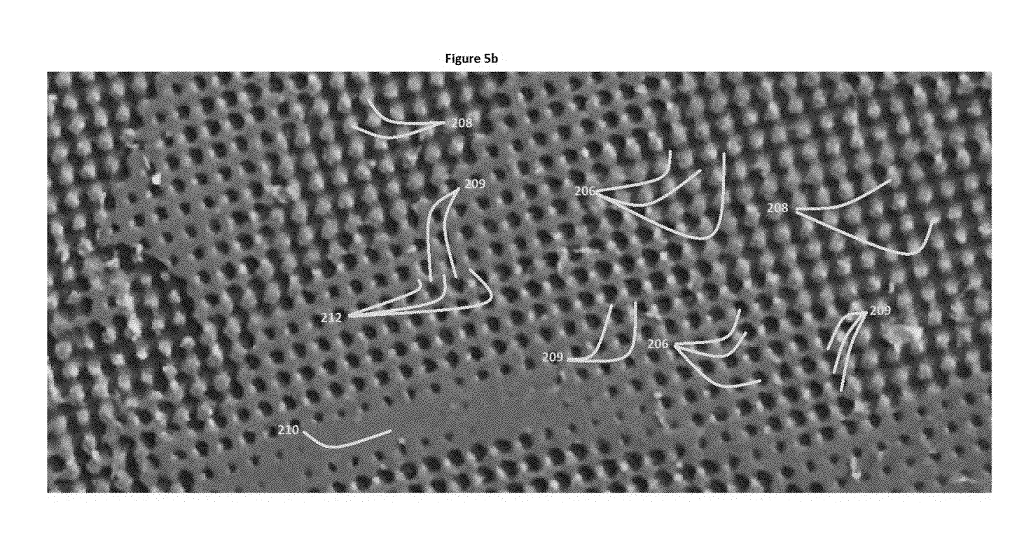

Referring to FIGS. 3-5b, a stamp 200 is depicted according to one embodiment of the present invention. Stamp 200 includes a base portion 202—which, again can be mounted on a handle 203 such as a wooden block, but is not necessarily so—and one or more stamping surface sections 204. The stamping surface sections 204 are characterized by a blend of small stamping singularities 208; conjoined singularities 212; and larger sections of fused singularities 210 all of substantially uniform height. As can be best seen in FIGS. 5 and 5b, the singularities 208 can be small protrusions separated by gaps 206. The singularities 208 are typically of uniform height relative to the base 202 but can vary in width and depth and cross-sectional shape. In certain embodiments, the singularities 208 will be substantially square or polygonal in cross-sectional shape. In other embodiments, their cross-sectional shape could be substantially circular. In certain embodiments, the cross-sectional shape of the singularities 208 could vary within a single stamp 200. In certain embodiments, the singularities 208 could be tapered or conical from top to bottom or bottom to top (relative to the base 202). What is key is that the singularities 208 include a top surface that is capable of receiving a measure of ink and then transferring that ink to an article to be stamped when the stamp 200 is pressed upon it. As such, it is generally desirable for the top surface of the singularities 208 to be flat or substantially flat. Even so, in certain embodiments rounded or pointed top surfaces may be utilized.

Surrounding the singularities 208 are gaps 206. The gaps 206 are recessed relative to the singularities 208. As such, when applied to an ink source, the ink will generally not adhere to the gaps 206. Even if it does (e.g. because the user presses too deeply into the ink source), when properly used, that ink will generally not come into contact with the article being stamped. As such, when the stamp is lifted, the gaps 206 correspond to inkless sections on the stamped article. Gaps 206 can vary in size, shape and depth. In certain embodiments, they can be substantially square or polygonal. In other embodiments, they could be substantially circular in shape. In certain embodiments, the shape of the gaps 206 could also vary within a single stamp 200. Similarly, the depth of the gaps 206 relative to the top surface of the singularities 208 can vary from embodiment to embodiment. In order to properly function as gaps 206, it is only necessary that they be sufficiently recessed to substantially prevent the transfer of ink to the article being stamped.

The conjoined singularities 212 can be seen in FIG. 5. The conjoined singularities 212 can contain the same features as the singularities 208 discussed previously. However, they are characterized by a connection 209 (FIG. 5b) between two or more adjacent singularities 208. The connection 209 could be in a variety of directions. In FIGS. 5 and 5b, the connections 209 are shown as substantially horizontal and vertical connections. However, in certain embodiments, the connectivity could extend diagonally. The connections 209 between the conjoined singularities 212 are also substantially the same height as the singularities 208 themselves. Thus, the conjoined singularities 212 can create a linear stamping image as opposed to a discrete spot as created by the non-conjoined singularities 208.

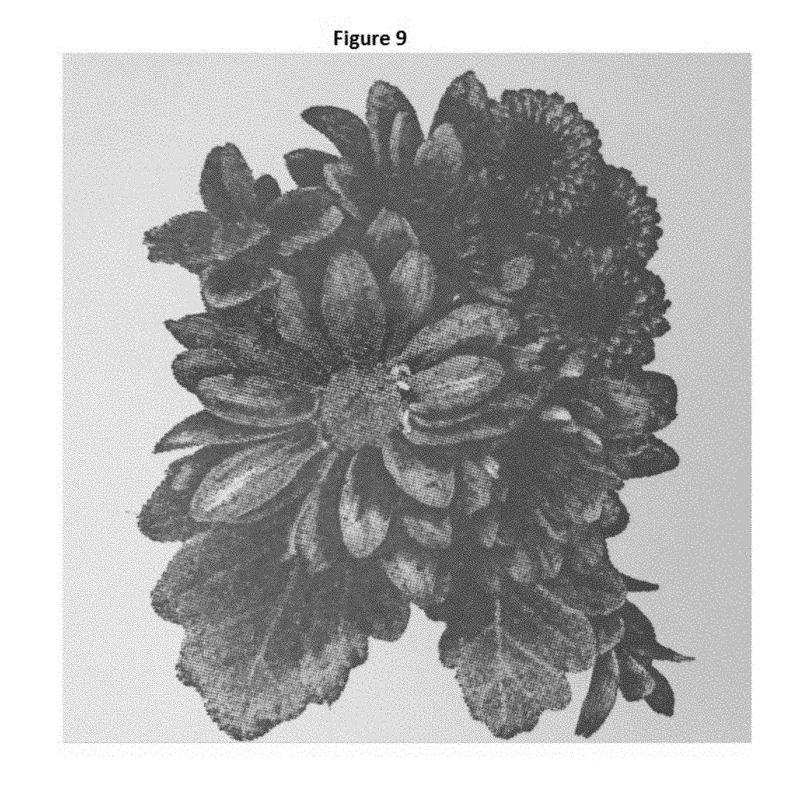

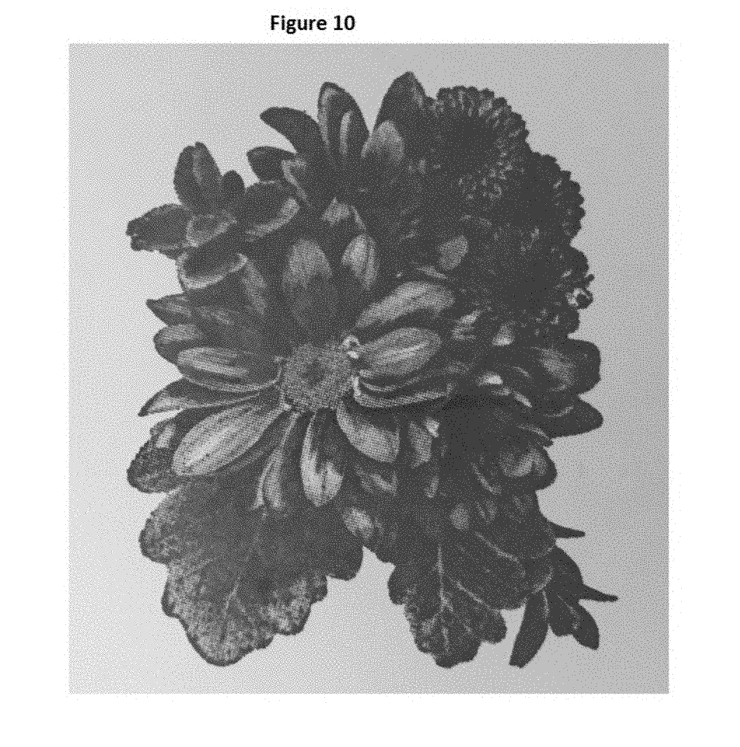

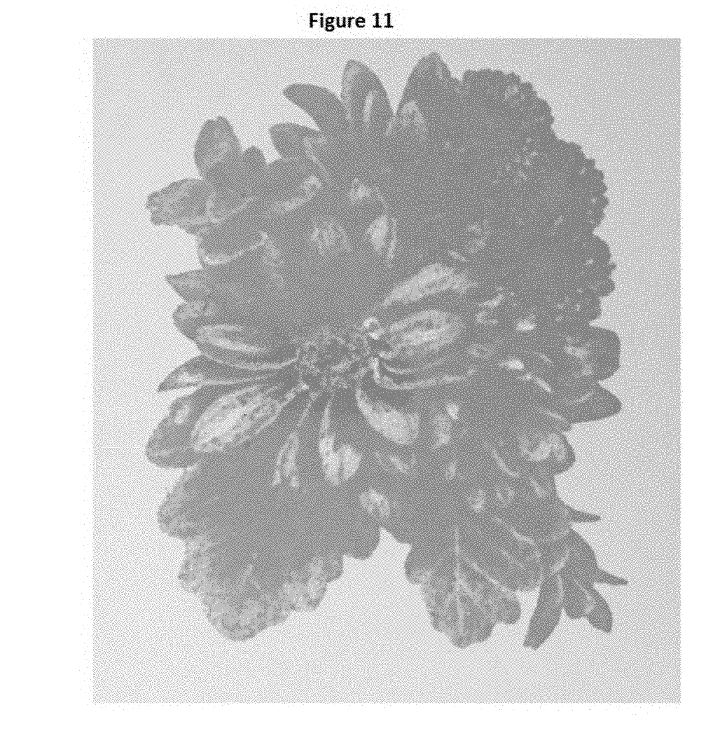

The larger sections of fused singularities 210 act as a substantially uniform stamping surface and because of the larger stamping surface area, they allow larger quantities of ink to be applied to an article that corresponds to more darkly shaded areas. As can be seen in FIGS. 9-11, because of their relatively small stamping surface area, the singularities 208 allow for discrete quantities of ink to be applied to an article. By spacing the singularities 208 apart with larger gap 206 sections, the stamping effect is a lightly shaded area. The conjoined singularities 212, because of the increased stamping surface area provided by the combined singularities 208 and connections 209 correspond to moderately darker shading in the stamped image.

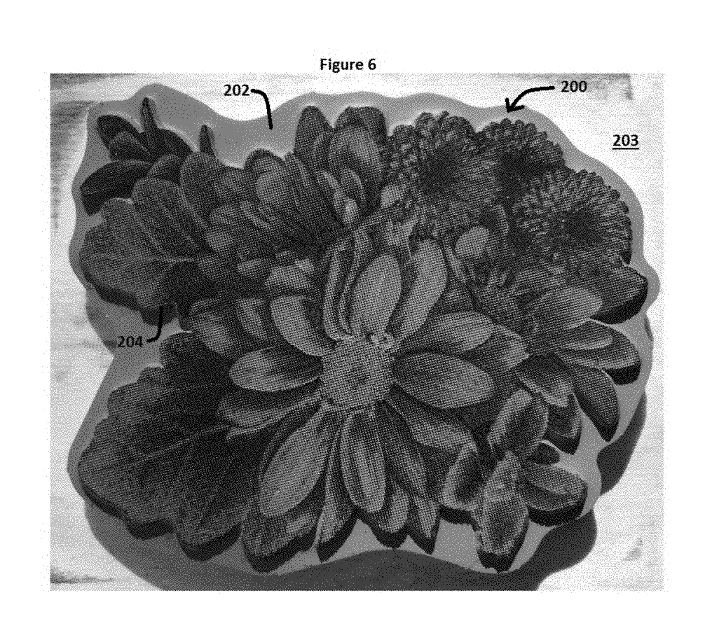

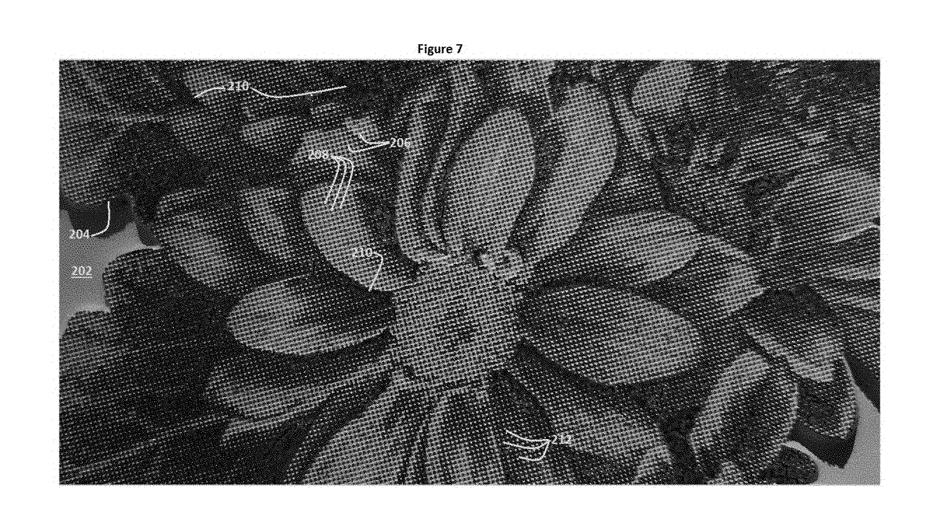

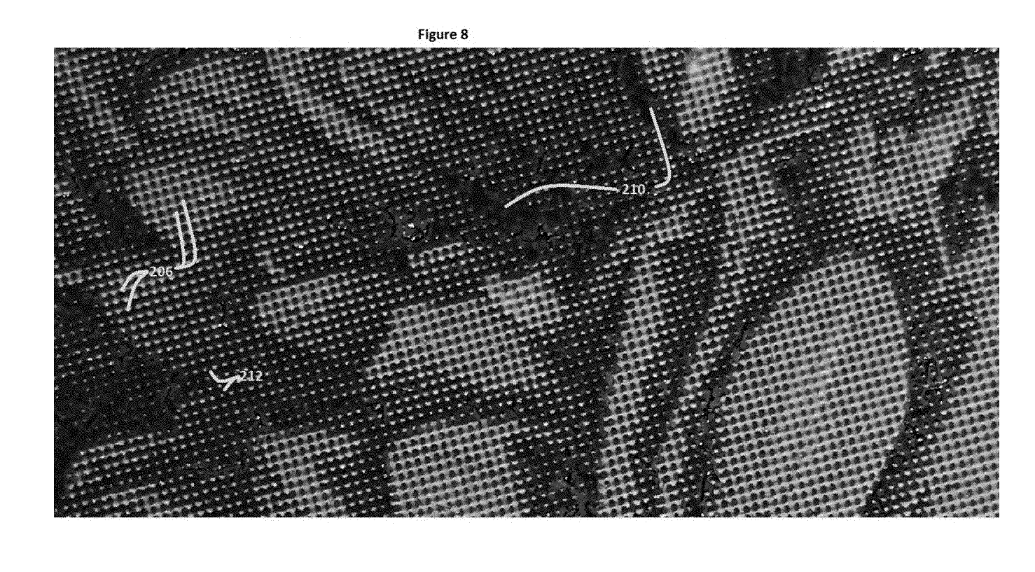

FIGS. 6-8 depict certain embodiments of the present invention with ink applied to the stamping surface 204. FIG. 6 is a full stamp view while FIG. 7 depicts a magnified view of the stamping surface with ink applied. FIG. 8 depicts an even further magnified view of the stamping surface 204 with ink applied. As can be seen, the ink distribution corresponds to sections of singularities 208, conjoined singularities 212 and fused singularities 210 with the highest concentration of ink at the fused singularities 210, moderate concentrations of ink at the conjoined singularities 212 and lightest concentrations of ink at the sections of individual singularities 208.

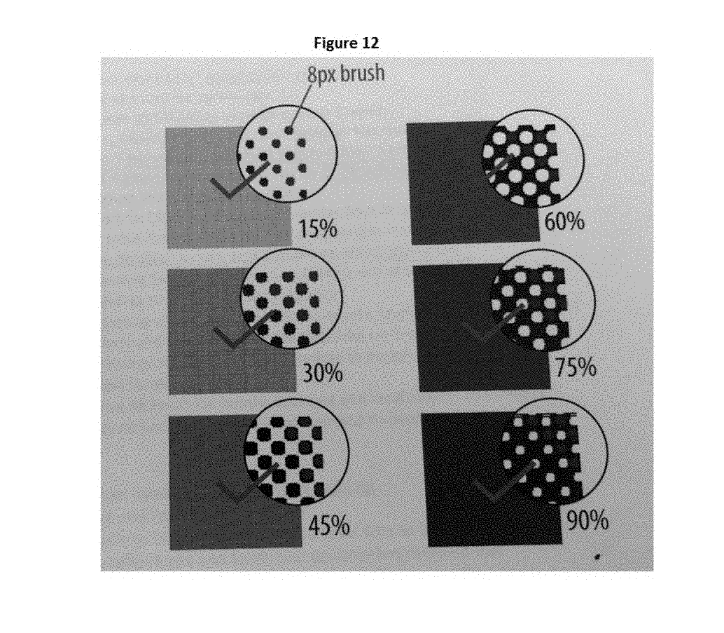

With regard to manufacturing, in a typical red rubber stamp, graphical artwork is created that is used as a template for a magnesium plate that then serves as a mold for a matrix board which is in turn a mold for the red rubber. The use of such templates in chemical etching techniques is well known and is not discussed in detail herein. However, it has been discovered that specific adjustments in pixilation settings in the graphical artwork allow for better magnesium etching that translates into a working stamp with viable singularities 208 capable of transferring ink from an ink source to an article being stamped. Referring to FIG. 12, in one embodiment, the pixilation settings are approximately 600 dots per inch (DPI) with the lightest area set at approximately 15% black (plus or minus 3%). The bitmap is set at 1200 and the lines per square inch (LSI) is set at approximately 65-80. These settings result in a pixel size that is at least approximately 7px.

However, in other embodiments, the pixilation settings could be anywhere in the range of approximately 300-1500 dots per inch (DPI); bitmap settings at approximately 600-1500; and LSI settings of approximately 45-85 with approximately 7-80 percentage black. Thus, by adjusting the artwork resolution settings, an optimized balance of clarity and manufacturing viability is achieved.

The graphical artwork output is typically in PDF or TIFF format, though other suitable outputs would be apparent to one skilled in the art. Various software systems can be utilized to create the desired output including but not limited to Adobe Photoshop and Adobe Illustrator available from Adobe Systems of San Jose, Calif.

Numerous known etching techniques could then be utilized to capture the artwork onto a magnesium plate. Chemical etching has been specifically referred to, but other etching techniques as would be apparent to one skilled in the art could also be utilized including, but not limited to photoengraving and laser engraving.

Once the magnesium plate has been created, it can be used through known techniques to form matrix boards which serve as the molds for the rubber stamps.

### VARIATIONS

The methods discussed above refer to the use of chemical etching techniques in creating the magnesium plate. However, the present invention is not intended to be limited to this one particular process. Rather, the invention contemplates any other plate engraving methods as would be apparent to one skilled in the art into which the pixilation settings as discussed above can be incorporated and by which viable singularities 208 can ultimately be molded. In certain embodiments, metals other than magnesium may also be desirable in creating the plate.

Moreover, while the drawings depict the present invention as a red rubber stamp, it is noted that other known stamping materials could be utilized including, but not limited to photopolymers. With respect to manufacturing of the photopolymer stamps, a similar graphical artwork output can be utilized. However, instead of creating a magnesium plate, in photopolymer production a mask and negative is created that can then be printed on acetate or other backing materials through known techniques.

Numerous other modifications and alternative arrangements may be devised by those skilled in the art without departing from the spirit and scope of the present invention.

What is claimed is:

1) A stamp comprising:
a) a base; and
b) a stamping surface wherein the stamping surface further comprises one or more singularities; one or more conjoined singularities; and one or more fused singularity sections all of substantially uniform height.

2) The stamp of claim 1, wherein the singularities are protrusions separated by one or more gaps.

3) The stamp of claim 1, wherein the singularities are substantially polygonal in cross-sectional shape.

4) The stamp of claim 1, wherein the singularities are substantially circular in cross-sectional shape.

5) The stamp of claim 1, wherein the singularities have a top surface that is substantially flat.

6) The stamp of claim 1, wherein the singularities have a top surface that is substantially rounded.

7) The stamp of claim 2, wherein the gaps are substantially polygonal.

8) The stamp of claim 2, wherein the gaps are substantially circular.

9) The stamp of claim 1 further comprising one or more connections between the conjoined singularities, wherein the connections are substantially the same height as the stamping surface.

10) The stamp of claim 9, wherein the connections are part of the stamping surface.

11) The stamp of claim 9, wherein the connections are substantially horizontal.

12) The stamp of claim 9, wherein the connections are substantially vertical.

13) The stamp of claim 9, wherein the connections are substantially diagonal.

14) A method of manufacturing a stamp comprising the steps of:
a) creating a graphical stamp image, wherein the graphical stamp image has a dots per inch (DPI) setting of approximately 300-1500; a bitmap setting of approximately 600-1500; a lines per square inch (LSI) setting of approximately 45-85 and a lightest area setting of approximately 7-80 percent black;
b) engraving a three-dimensional likeness of the graphical stamp image into a quantity of magnesium;
c) forming one or more matrix boards from the engraved three-dimensional likeness of the graphical stamp image in the quantity of magnesium;
d) depositing a quantity of precursor material into the one or more matrix boards;
e) applying heat to the one or more matrix boards and the quantity of precursor material, whereby the quantity of precursor materials melts to form a negative shape of the one or more matrix boards;
f) allowing the precursor materials to cool; and
g) removing the cooled precursor materials from the one or more matrix boards, wherein the cooled precursor materials are the stamp.

15) The method of claim 14, wherein the graphical stamp image has a dots per inch (DPI) setting of approximately 600; a bitmap setting of approximately 1200; a lines per square inch (LSI) setting of approximately 65-80 and a lightest area setting of approximately 15 percent black.

16) The method of claim 14 wherein the one or more precursor materials is red rubber.

17) The method of claim 14 wherein the quantity of magnesium is a magnesium plate.
